(19) United States
(12) Patent Application Publication
(10) Pub. No.: US 2020/0174499 A1
(43) Pub. Date: Jun. 4, 2020

(54) AIRCRAFT CONTROL SYSTEM

(71) Applicant: DENSO CORPORATION, Kariya-city (JP)

(72) Inventors: Yotaro MOTEGI, Nisshin-city (JP); Tetsuji MITSUDA, Kariya-city (JP)

(21) Appl. No.: 16/686,268

(22) Filed: Nov. 18, 2019

(30) Foreign Application Priority Data
Dec. 4, 2018 (JP) 2018-227275

(51) Int. Cl. G05D 1/08; B64C 39/02; G05D 1/00; G01S 17/933; G01S 17/42

(52) U.S. Cl. CPC G05D 1/0808; B64C 39/024; G05D 1/0094; G01S 17/933; B64D 47/08; B64C 2201/141; B64C 2201/146; B64C 2201/027; B64C 2201/127; G01S 17/42

(57) ABSTRACT

An aircraft control system is provided to include an unmanned aircraft, a retroreflective member, an installation base, a retroreflective member driver, and a survey instrument. The retroreflective member reflects light to an emission source. The installation base is provided integrally or separately with the aircraft; on the installation base, the retroreflective member is installed. The retroreflective member driver drives the retroreflective member so as to be movable relative to the installation base. The survey instrument tracks the retroreflective member based on the light reflected by the retroreflective member and surveys a distance to the retroreflective member and an angle of the retroreflective member, providing a survey result. Herein, a latest flight orientation of the aircraft is estimated from (i) a movement trajectory of the retroreflective member acquired from the survey result and (ii) a change in the flight orientation of the aircraft.

### CROSS REFERENCE RELATED APPLICATION

The present application claims the benefit of priority from Japanese Patent Application No. 2018-227275 filed on Dec. 4, 2018. The entire disclosure of the above application is incorporated herein by reference.

### TECHNICAL FIELD

The present disclosure relates to an aircraft control system.

### BACKGROUND

A small aircraft so-called drone has recently become widespread. The aircraft flies mainly by wireless or wired remote control by an operator on the ground, or by autonomous control without operation of an operator according to a preset flight plan. In any case, the flight position or flight orientation of the aircraft is monitored at a position on a ground base or an operator distant from the aircraft.

### SUMMARY

According to an example of the present disclosure, an aircraft control system is provided to include an unmanned aircraft, a retroreflective member, an installation base, a retroreflective member driver, and a survey instrument. The retroreflective member is configured to reflect light to an emission source. The installation base is provided integrally or separately with the aircraft; on the installation base, the retroreflective member is installed. The retroreflective member driver is configured to drive the retroreflective member so as to be movable relative to the installation base. The survey instrument is configured to track the retroreflective member based on the light reflected by the retroreflective member and survey a distance to the retroreflective member and an angle of the retroreflective member, to provide a survey result. Herein, a latest flight orientation of the aircraft is estimated from (i) a movement trajectory of the retroreflective member acquired from the survey result and (ii) a change in the flight orientation of the aircraft.

### BRIEF DESCRIPTION OF DRAWINGS

The above and other objects, features and advantages of the present disclosure will become more apparent from the following detailed description made with reference to the accompanying drawings, In the drawings:

FIG. 1 is a schematic view showing a schematic configuration of an aircraft control system according to a first embodiment;

FIG. 2 is a block diagram showing a configuration of an aircraft control system according to the first embodiment;

FIG. 3 is a view for explaining a coordinate system of the aircraft control system according to the first embodiment;

FIG. 4 is a flowchart showing a sequence of processing by the aircraft control system according to the first embodiment;

FIG. 5 is a flowchart showing a sequence of processing by an aircraft control system according to a second embodiment;

FIG. 6 is a flowchart showing a sequence of processing of an aircraft control system according to a third embodiment;

FIG. 7 is a schematic view showing a schematic configuration of an aircraft control system according to a fourth embodiment;

FIG. 8 is a flowchart showing a sequence of processing by the aircraft control system according to the fourth embodiment;

FIG. 9 is a block diagram showing a configuration of an aircraft control system according to a fifth embodiment;

FIG. 10 is a flowchart showing a sequence of processing by the aircraft control system according to the fifth embodiment;

FIG. 11 is a block diagram showing the configuration of an aircraft control system according to a sixth embodiment;

FIG. 12 is a flowchart showing a sequence of processing of the aircraft control system according to the sixth embodiment;

FIG. 13 is a schematic view showing a configuration of an aircraft control system according to a seventh embodiment; and

FIG. 14 is a schematic view showing a configuration of an aircraft control system according to another embodiment.

### DETAILED DESCRIPTION

Hereinafter, several embodiments of an aircraft control system using an aircraft will be described based on the drawings. Elements that are substantially the same in the embodiments are denoted by the same reference signs and will not be described.

### First Embodiment

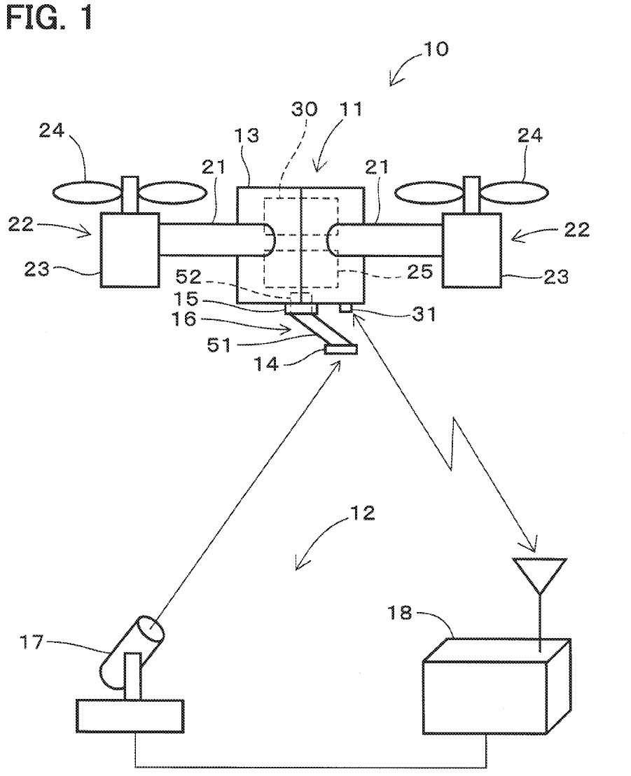

As shown in FIG. 1, an aircraft control system 10 according to a first embodiment includes an aircraft 11 and a ground facility 12. The aircraft 11 includes a main body 13, a retroreflective member 14, an installation base 15, and a retroreflective member driver 16. In addition, the ground facility 12 includes a survey instrument 17 and a ground control apparatus 18. The aircraft 11 reflects the light emitted from the survey instrument 17 in the ground facility 12 by using the retroreflective member 14. The survey instrument 17 in the ground facility 12 uses the light reflected by the retroreflective member 14 to track the aircraft 11 to acquire the flight data of the aircraft 11. The retroreflective member 14 is installed in the installation base 15.

The main body 13 of the aircraft 11 includes arms 21 and thrusters 22. The arms 21 are provided so as to individually extend radially from the main body 13; the thrusters 22 are provided at the respective tips of the arms. In the main body 13, the arms 21 are not limited to extend radially, but may be configured differently. For instance, the arms may be configured to be an annular shape; a plurality of thrusters 22 are provided in the circumferential direction of the arms. Further, the number of arms 21 and thrusters 22 can be set optionally as long as it is two or more.

The thrusters 22 each have a motor 23 and a propeller 24. The motor 23 is a drive source that drives the propeller 24. The motor 23 is driven by electric power supplied from a power source such as a battery 25. The propeller 24 is rotationally driven by the motor 23. Further, the pitch of the propeller 24 is changed by a pitch changing mechanism (not shown). The thruster 22 generates a propulsive force by driving the propeller 24 with the motor 23. In this case, the magnitude and the direction of the propulsive force generated from the thruster 22 are controlled by changing the number of rotations of the motor 23 and the pitch of the propeller 24.

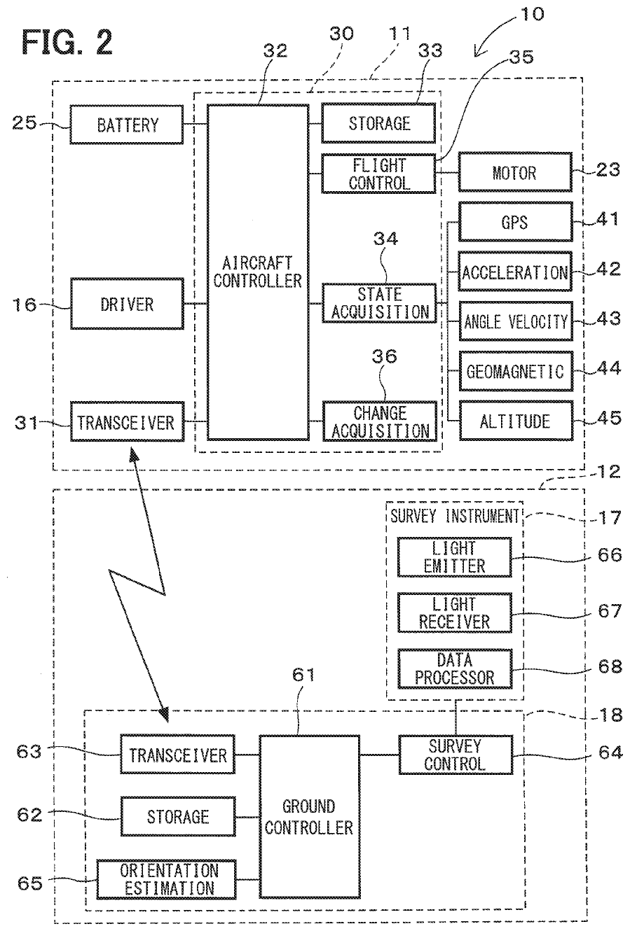

The aircraft 11 includes an aircraft control apparatus 30 and a transceiver 31, which are connected with each other via a communication link or a signal link. The transceiver 31 communicates with the ground facility 12 via a wireless or wired communication link. The aircraft control apparatus 30 includes (i) an aircraft controller 32 for controlling the entire aircraft 11 and (ii) a storage 33, which are connected with each other via a communication link or a signal link, as shown in FIG. 2. The storage 33 has, for example, a non-volatile memory. The storage 33 stores a flight plan set in advance as data. The flight plan includes, for example, a flight altitude and a flight route on which the aircraft 11 flies, and the like. The aircraft controller 32 includes a flight state acquisition module 34, a flight control module 35, and an orientation change acquisition module 36. Here, “module” may be also referred to as a circuit.

The aircraft controller 32 may be provided as one or more controllers 32. Note that an individual one of one or more controllers 32 may be configured by including (i) circuitry or hardware circuit (which may be hereinafter referred to a hardware configuration), or (ii) a central processing unit (CPU) in a computer along with memory (e.g., ROM, RAM) storing a control program including instructions executed by the CPU (which may be hereinafter referred to a software configuration), or (iii) both the hardware circuit and the CPU along with memory (which may be hereinafter referred to as a combination of the hardware configuration and the software configuration). Furthermore, similar to the aircraft controller 32, an individual one of the flight state acquisition module/circuit 34, the flight control module/circuit 35, and the orientation change acquisition module/circuit 36 in the aircraft controller 32 may be configured to include (i) a hardware configuration or (ii) a software configuration, or (iii) a combination of the hardware configuration and the software configuration.

The following will describe, as one of examples, a configuration in which the aircraft controller 32 is configured to include a computer containing CPU, RAM, ROM, input and output interfaces, a bus connecting the foregoing, and the like. The modules 34, 35, 36 are achieved in the aircraft controller 32 by the CPU executing a computer readable instructions in a control program stored in the ROM or the storage 33 or the like. The storage 33 has, for example, a non-volatile memory. The storage 33 stores a flight plan set in advance as data. The flight plan includes, for example, a flight altitude and a flight route on which the aircraft 11 flies, and the like. The transceiver 31 communicates with the ground facility 12 via a wireless or wired communication link.

The flight state acquisition module 34 acquires the flight state of the aircraft 11 from the inclination of the main body 13 of the aircraft 11 and the acceleration applied to the main body 13 and the like. Specifically, the flight state acquisition module 34 is connected with various sensors such as a GPS (Global Positioning System) sensor 41, an acceleration sensor 42, an angular velocity sensor 43, a geomagnetic sensor 44, and an altitude sensor 45. The acceleration sensor 42, the angular velocity sensor 43, the geomagnetic sensor 44, and the altitude sensor 45 each correspond to an internal sensor that autonomously acquires the flight state of the aircraft 11 and its change amount without requiring information from the outside of the aircraft 11. The GPS sensor 41 receives a GPS signal output from a GPS satellite. Therefore, the GPS sensor 41 corresponds to an external sensor that acquires information from the outside of the aircraft 11. Further, the acceleration sensor 42 detects an acceleration applied to the main body 13 of the aircraft 11 in three axial directions of x-axis, y-axis, and z-axis in three dimensions. The angular velocity sensor 43 detects an angular velocity applied to the main body 13 in three axial directions in three dimensions. The geomagnetic sensor 44 detects a geomagnetism in three axial directions in three dimensions. The altitude sensor 45 detects an altitude in the vertical direction based on the air pressure and the like. The GPS sensor 41, the acceleration sensor 42, and the angular velocity sensor 43 connected with the flight state acquisition module 34 correspond to a velocity information sensor or detector. The GPS sensor 41 corresponds to a translational position sensor or detector. The GPS sensor 41 may be replaced with the GNSS (Global Navigation Satellite System) sensor.

The flight state acquisition module 34 detects the flight orientation, flight direction, and flight velocity of the main body 13 from the GPS signals received by the GPS sensor 41, the acceleration detected by the acceleration sensor 42, the angular velocity detected by the angular velocity sensor 43, the geomagnetism detected by the geomagnetic sensor 44. Further, the flight state acquisition module 34 detects the flight position of the main body 13 from the GPS signal detected by the GPS sensor 41 and the detection values of various sensors. Furthermore, the flight state acquisition module 34 detects the flight altitude of the main body 13 from the altitude detected by the altitude sensor 45. Thus, the flight state acquisition module 34 detects information necessary for the flight of the main body 13 as the flight state such as the flight orientation, flight position, and flight altitude of the main body 13. In addition to the above sensors, the flight state acquisition module 34 may be connected to other sensors such as a camera (not shown) that acquires a visible image around the main body 13 or a LIDAR (Light Detection And Ranging) (not shown) that measures the distance to an object around the main body 13. These camera and LIDAR also each correspond to an external sensor.

The flight control module 35 controls the propulsive force of the thruster 22 by changing the number of revolutions of the motor 23 and the pitch of the propeller 24, The flight control module 35 controls the flight of the main body 13 by the autonomous control mode and the remote control mode. The autonomous control mode is a flight mode in which the aircraft 11 is caused to fly autonomously without the operation of the operator or the guidance from the ground facility 12. In the autonomous control mode, the flight control module 35 automatically controls the flight of the aircraft 11 in accordance with the flight plan stored in the storage 33. That is, in the autonomous control mode, the flight control module 35 controls the propulsive force of the thruster 22 based on the flight plan and the flight state of the aircraft 11 detected by the flight state acquisition module 34. Thereby, the flight control module 35 automatically causes the aircraft 11 to fly according to the flight plan regardless of the operation of the operator or the guidance from the ground facility 12. On the other hand, the remote control mode is a flight mode in which the aircraft 11 is caused to fly according to the operation of the operator or the guidance from the ground facility 12. In the remote control mode, the ground facility 12 remotely controls the flight state of the aircraft 11. When the operator manipulates the flight state of the aircraft 11, the operator inputs the intention of the manipulation through the ground facility 12. Further, when the ground facility 12 guides the aircraft 11, the aircraft 11 is guided along a preset flight plan. The flight control module 35 controls the propulsive force of the thruster 22 based on the guidance by the ground facility 12 and the flight state acquired by the flight state acquisition module 34. Thereby, the flight control module 35 causes the aircraft 11 to fly based on the operation by the operator's intention or the guidance from the ground facility 12.

The orientation change acquisition module 36 acquires the change amount of the flight orientation of the aircraft 11. Specifically, the orientation change acquisition module 36 acquires the amount of change per unit time or the amount of change from a reference time to a certain time as the change in flight orientation based on the temporal change of the flight orientation of the aircraft 11 acquired by the flight state acquisition module 34.

In the first embodiment, as shown in FIG. 1, the retroreflective member driver 16 drives the retroreflective member 14 provided in the installation base 15. The retroreflective member driver 16 drives the retroreflective member 14 in accordance with an instruction from the aircraft controller 32 of the aircraft control apparatus 30, Specifically, the retroreflective member driver 16 includes a support member 51 and an actuator 52. The support member 51 is provided between the retroreflective member 14 and the installation base 15 of the aircraft 11. In other words, the retroreflective member 14 is provided or supported at one end of the support member 51; the installation base 15 is provided at the other end of the support member 51. The actuator 52 is provided on the main body 13 side of the support member 51, and drives the retroreflective member 14 through the support member 51 based on an instruction from the aircraft controller 32. Thus, in the first embodiment, the retroreflective member 14 is provided integrally with the installation base 15 of the aircraft 11 while the retroreflective member driver 16 is interposed between the retroreflective member 14 and the installation base 15. The retroreflective member 14 reflects light emitted from the survey instrument 17 of the ground facility 12 toward the survey instrument 17. That is, the retroreflective member 14 reflects the light emitted from the survey instrument 17 toward the survey instrument 17 which is a light source.

The ground facility 12 includes the survey instrument 17 and the ground control apparatus 18, which are connected with each other via a communication link or a signal link, as described above. As shown in FIG. 2, the ground control apparatus 18 includes a ground controller 61, a storage 62, and a ground transceiver 63, which are connected with each other via a communication link or a signal link. The storage 62 includes a storage medium such as a non-volatile memory or a magneto-optical disk. The ground transceiver 63 communicates with the transceiver 31 in the aircraft 11 by wired or wireless communication. The ground controller 61 includes a survey control module 64, and a flight orientation estimation module 65. Note that, as described later in other embodiments, the ground controller 61 further includes a reliability calculation module 81 and a sensor correction module 82. Here, such a “module” may be also referred to as a circuit.

The ground controller 61 may be provided as one or more controllers 61. Similar to the aircraft controller 32, an individual one of one or more controllers 61 may be configured by including (i) circuitry or hardware circuit (which may be hereinafter referred to a hardware configuration), or (ii) a central processing unit (CPU) in a computer along with memory (e.g., ROM, RAM) storing a control program including instructions executed by the CPU (which may be hereinafter referred to a software configuration), or (iii) both the hardware circuit and the CPU along with memory (which may be hereinafter referred to as a combination of the hardware configuration and the software configuration). Furthermore, similar to the ground controller 61, an individual one of the survey control module/circuit 64, the flight orientation estimation module/circuit 65, the reliability calculation module/circuit 81, and the sensor correction module 82 in the ground controller 61 may be configured by including (i) a hardware configuration, or (ii) a software configuration, or (iii) a combination of a hardware configuration and a software configuration.

The following will describe, as one of examples, a configuration in which the ground controller 61 is configured to include a computer containing CPU, RAM, ROM, input and output interfaces, a bus connecting the foregoing, and the like. The modules 64, 65, 81, 82 are achieved in the ground controller 61 by the CPU executing a computer readable instructions in a control program stored in the ROM or the storage 62 or the like.

The survey instrument 17 includes a light emitter 66, a light receiver 67, and a data processor 68. The light emitter 66 emits light, such as a laser beam, for example. The light emitter 66 emits the laser light continuously or periodically at predetermined intervals. The light receiver 67 receives the light reflected by the retroreflective member 14 provided in the aircraft 11. That is, the light receiver 67 receives the laser beam emitted from the light emitter 66 and reflected by the retroreflective member 14 of the aircraft 11.

The survey control module 64 controls the survey instrument 17. Specifically, the survey control module 64 drives the survey instrument 17 in a predetermined direction using, for example, a motor or an actuator (not shown), and causes the survey instrument 17 to track the aircraft 11 flying. At the same time, the survey control module 64 controls the light emitter 66 to emit light and controls the light receiver 67 to receive light. As described above, the survey control module 64 controls the emission of light to the aircraft 11 and the reception of light reflected by the retroreflective member 14 while causing the survey instrument 17 to track the aircraft 11.

The survey instrument 17 obtains the distance to the aircraft 11 and the angle of the aircraft 11 based on the light reflected by the retroreflective member 14 of the aircraft 11. The angle of the aircraft 11 is a ground angle p0 set as a reference point in the survey instrument 17 in the ground facility 12. The angle of the aircraft 11 signifies, around the ground origin p0, an angle in the horizontal direction and an angle in the vertical direction. That is, when the ground origin p0 is set in the survey instrument 17, a horizontal angle of 0 to 360 degrees is set in the horizontal direction, and a vertical angle of 0 to 90 degrees is set in the vertical direction. In this case, “0 degree” which is a reference of the horizontal angle is optionally set to “north” in the map coordinates, for example. Further, “0 degree” which is a reference of the vertical angle is set in a plane parallel to the ground, for example. The survey instrument 17 acquires the horizontal angle and vertical angle of the aircraft 11 and the distance to the aircraft 11 from the light reflected by the retroreflective member 14.

The flight orientation estimation module 65 estimates the latest flight orientation of the aircraft 11 from the movement trajectory of the retroreflective member 14 and the change amount of the flight orientation of the aircraft 11 acquired by the orientation change acquisition module 36. That is, the flight orientation estimation module 65 acquires the movement trajectory of the aircraft 11 (i.e., the movement trajectory of the retroreflective member 14) from the distance to the aircraft 11, the horizontal angle, and the vertical angle, which are acquired through the survey instrument 17. Further, the flight orientation estimation module 65 acquires the change amount of the flight orientation of the aircraft 11 from the orientation change acquisition module 36 of the aircraft 11 through the transceiver 31 of the aircraft 11 and the ground transceiver 63 of the ground facility 12. The flight orientation estimation module 65 estimates the latest flight orientation of the aircraft 11 from the acquired movement trajectory and the change amount of the flight orientation.

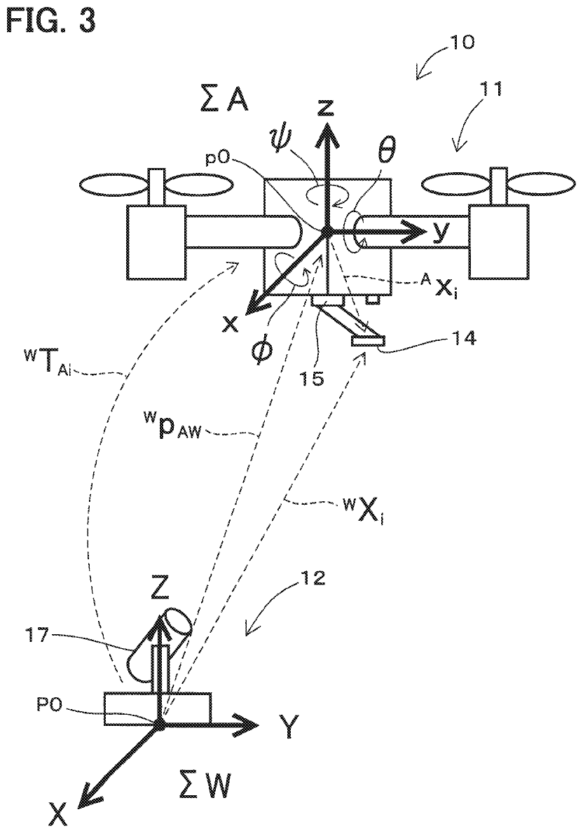

Next, the estimation of the flight orientation of the aircraft 11 by the flight orientation estimation module 65 will be described in detail. First, a coordinate system in the aircraft control system 10 in the present embodiment will be described based on FIG. 3. In the aircraft control system 10 of the present embodiment, an aircraft coordinate system ΣA and a survey instrument coordinate system ΣW are set. The aircraft coordinate system ΣA is a coordinate system set in the aircraft 11. On the other hand, the survey instrument coordinate system EW is a coordinate system set in the survey instrument 17 in the ground facility 12.

In the aircraft coordinate system ΣA, three three-dimensional axes of x-axis, y-axis and z-axis are defined. These correspond to the roll axis, the pitch axis, and the yaw axis, respectively. In the aircraft coordinate system ΣA, the rotation angle φ about the roll axis, which is the x axis, is a roll angle. Similarly, the rotation angle θ about the pitch axis, which is the y axis, is a pitch angle; the rotation angle iv about the yaw axis, which is the z axis, is a yaw angle. In the aircraft coordinate system ΣA, the reference origin is an aircraft origin p0. Further, in the survey instrument coordinate system ΣW, three three-dimensional axes of the X axis, the Y axis, and the Z axis are defined as in the case of the aircraft coordinate system ΣA. In the survey instrument coordinate system EW, the reference origin is a ground origin P0.

Here, the coordinate of the retroreflective member 14 with respect to the aircraft origin p0 is set as coordinate ^{A}Xᵢ. This coordinate ^{A}Xᵢ is coordinate of the retroreflective member 14 provided on the aircraft 11, and is a known value that can be obtained as an actual measurement value. The coordinate of the retroreflective member 14 with respect to the ground origin P0 is set as the coordinate ^{W}Xᵢ. The coordinate ^{W}Xᵢ is a known value that can be obtained from an actual measurement value up to the retroreflective member 14 measured by the survey instrument 17. On the other hand, the position ^{W}p_{AW} of the aircraft origin p0 with respect to the ground origin P0 changes depending on the flight position and flight orientation of the aircraft 11. Therefore, the position of the aircraft origin p0 of the origin of the aircraft coordinate system ΣA and the rotation angles φ, θ, and ψ of the respective axes in the aircraft coordinate system ΣA are respectively unknown and become targets for estimations by the flight orientation estimation module 65.

That is, both of

(i) aircraft origin position ^{W}p_{AW}=(pₓ, p_{y}, p_{z})^{t} in aircraft coordinate system ΣA, and

(ii) each axis rotation angle (φ, θ, ψ)^{t} in aircraft coordinate system ΣA are targets for estimation by the flight orientation estimation module 65.

Here, t means that it is a transposed matrix of (pₓ, p_{y}, p_{z}). Thus, the flight orientation estimation module 65 estimates the flight orientation of the aircraft 11 using the following known values;

(i) Coordinate ^{A}Xᵢ=(xᵢ, yᵢ, zᵢ)^{t},

(ii) Coordinate ^{W}Xᵢ=(Xᵢ, Yᵢ, Zᵢ)^{t},

(iii) Each axis rotation amount (Δφᵢ, Δθᵢ, Δψᵢ)^{t} measured from the start of estimation; and

(iv) Translational displacement measured from the start of estimation ^{W}p_{AWi}=(Δpₓᵢ, Δp_{yi}, Δp_{zi})^{t}.

In the above, the coordinate ^{A}Xᵢ, the coordinate ^{W}Xᵢ, the position ^{W}p_{AW}, and the translational displacement ^{W}p_{AWi} are all vectors.

Next, a specific estimation technique by the flight orientation estimation module 65 will be described. The flight orientation estimation module 65 estimates the orientation of the aircraft 11 using the existing Direct Linear Transformation (DLT) technique using detection data acquired at a plurality of different points of times. The simultaneous transformation matrix between the two coordinate systems in any measurement step i is as in Expression 1 below.

$${}_{}^{W}{T}{}_{Ai}^{} = [ \begin{matrix}{C}_{z} ( ψ + Δ {ψ}_{i} ) {C}_{y} ( θ + & {}_{}^{W}{p}{}_{AW}^{} + {}^{W} Δ {p}_{AWi} \\ {Δθ}_{i} ) {C}_{x} ( φ + Δ {φ}_{i} ) & \\ 0 & 1\end{matrix} ] \qquad [ Expression 1 ]$$

Here, C_{z}(ψ), C_{y}(θ), Cₓ(φ) are vectors of rotation matrices of the respective axes. Expressions 2 and 3 below hold for the values measured in each measurement step i.

$$\begin{matrix}{}_{}^{W}{X}{}_{i}^{′} = {}_{}^{W}{T}{}_{Ai}^{} \cdot {}_{}^{W}{x}{}_{i}^{′} & [ Expression 2 ] \\ ( \begin{matrix}{X}_{i} \\ {Y}_{i} \\ {Z}_{i} \\ 1\end{matrix} ) = [ \begin{matrix}{C}_{z} ( ψ + Δ {ψ}_{i} ) {C}_{y} ( θ + & ( \begin{matrix}{p}_{x} + Δ {p}_{xi} \\ {p}_{y} + Δ {p}_{yi} \\ {p}_{z} + Δ {p}_{zi}\end{matrix} ) \\ {Δθ}_{i} ) {C}_{x} ( φ + Δ {φ}_{i} ) & \\ 0 & 1\end{matrix} ] \cdot ( \begin{matrix}{x}_{i} \\ {y}_{i} \\ {z}_{i} \\ 1\end{matrix} ) & [ Expression 3 ]\end{matrix}$$

In consideration of the instability of the orientation of the aircraft 11, at least three measurement steps are required to estimate the orientation of the aircraft 11 by solving the simultaneous Expressions according to Expressions 2 and 3.

However, ^{W}Δp_{AWi} obtained at each measurement step and each axis rotation amount (Δφᵢ, Δθᵢ, Δψᵢ)^{t} include measurement errors.

Therefore, ^{W}Δp_{AWi} and each axis rotation amount (Δφᵢ, Δθᵢ, Δψᵢ)^{t} are acquired in more measurement steps, and the flight orientation with the smallest error is estimated. Therefore, the above Expressions are transformed into the following Expression 4.

Mv=0(v=(pₓ, p_{y}, p_{z}, ϕ, θ, ψ, 1)^{t}) [Expression 4]

Here, M is a vector of parameter matrix of 3i rows and 7 columns. Therefore, the flight orientation estimation module 65 estimates the flight orientation v, which is a vector satisfying the following Expression 5. Note that My shown in Expression 4 is also a vector.

$${arg min}_{v} {‖ Mv ‖}^{2} \qquad [ Expression 5 ]$$

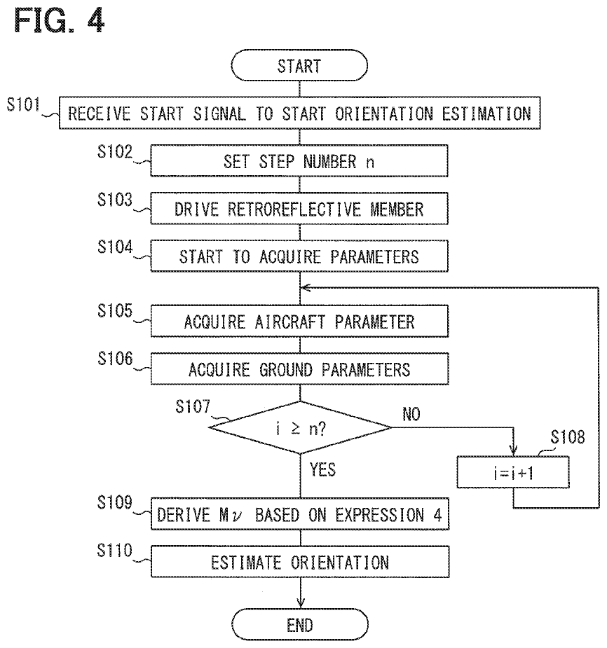

Next, the sequence of processing of a flowchart in the flight orientation estimation module 65 (i.e., the ground controller 61) having the above configuration will be described based on FIG. 4. When an orientation estimation start signal for starting the estimation of the flight orientation is received (S101), the flight orientation estimation module 65 sets the number of measurement steps as the number of steps n (S102).

The flight orientation estimation module 65 sets the number of steps n as the product of (i) the number of times of data detections per unit time and (ii) the detection time. In this case, the number of data detections per unit time and the detection time can be set optionally. As the number of steps n increases, the accuracy improves but the processing becomes complicated. Therefore, the flight orientation estimation module 65 optionally sets the number of steps n based on the estimation accuracy of the flight orientation required of the aircraft 11.

After setting the number of steps n, the flight orientation estimation module 65 drives the retroreflective member 14 by the retroreflective member driver 16 (S103). Thereby, the retroreflective member 14 is driven by the retroreflective member driver 16. In this case, the retroreflective member driver 16 moves the retroreflective member 14 relative to the installation base 15.

When the driving of the retroreflective member 14 is started, the flight orientation estimation module 65 starts acquisition of various parameters (S104). That is, the flight orientation estimation module 65 acquires various parameters for each measurement step i, with i=1 for the measurement step i. The flight orientation estimation module 65 acquires the coordinate ^{A}Xᵢ, translational displacement ^{W}Δp_{AWi}, and rotational amount of each axis (Δφᵢ, Δθᵢ, Δψᵢ)^{t} as aircraft side parameters in the measurement step i from the aircraft 11 and stores the acquired data (S105).

Further, the flight orientation estimation module 65 acquires the coordinate ^{W}Xᵢ as ground side parameters in measurement step i (S106) and stores the acquired data. In this case, the flight orientation estimation module 65 acquires ground side parameters based on the movement trajectory of the retroreflective member 14 in the aircraft 11 tracked by the survey instrument 17.

When the acquisition of the parameters in the measurement step i is completed in S105 and S106, the flight orientation estimation module 65 determines whether the measurement step i has reached the step number n set in S102 (S107). That is, the flight orientation estimation module 65 determines whether the detection data of the set step number n can be acquired. When the measurement step i has not reached the step number n (S107: No), the flight orientation estimation module 65 increments the measurement step i to i=i+1 (S108), and repeats the processing from S105 and S106. On the other hand, when the measurement step i has reached the step number n (S107: Yes), the flight orientation estimation module 65 derives My that becomes the above-mentioned “Expression 4” (S109). Furthermore, the flight orientation estimation module 65 estimates the flight orientation v satisfying “Expression 5” from My derived in S109 (S110).

In the first embodiment described above, the flight orientation estimation module 65 estimates the latest flight orientation of the aircraft 11. That is, the flight orientation estimation module 65 acquires the movement trajectory of the retroreflective member 14 from the survey result including the coordinate ^{W}Xᵢ of the moving retroreflective member 14 surveyed by the survey instrument 17.

Then, the flight orientation estimation module 65 acquires the amount of change of the flight orientation of the aircraft 11 through the orientation change acquisition module 36 as the amount of rotation of each axis (Δφᵢ, Δθᵢ, Δψᵢ)^{t} , and the translational displacement ^{W}Δp_{AWi}=(Δpₓᵢ, Δp_{yi}, Δp_{zi})^{t}.

The orientation change acquisition module 36 is provided in the aircraft 11, and acquires the change amount of the flight orientation of the aircraft 11 based on the output value of the internal sensor including the acceleration sensor 42 and the angular velocity sensor 43 acquired through the flight state acquisition module 34.

The flight orientation estimation module 65 estimates the latest flight orientation of the aircraft 11 from (i) the acquired coordinate ^{A}xᵢ=(xᵢ, yᵢ, zᵢ)^{t} and the coordinate ^{W}Xᵢ of the retroreflective member 14, and (ii) the rotation amount of each axis and translational displacement as the change amount of the flight orientation of the aircraft 11.

Thus, the flight orientation estimation module 65 estimates the flight orientation of the aircraft 11 based on the coordinate ^{A}Xᵢ and the coordinate ^{W}Xᵢ of the retroreflective member 14 corresponding to the movement trajectory of the retroreflective member 14. Therefore, it is sufficient for the survey instrument 17 to track one retroreflective member 14 (i.e., a single retroreflective member 14) provided in the aircraft 11.

In this case, the retroreflective member 14 to be tracked is driven relative to the known installation base 15 by the retroreflective member driver 16. Therefore, the movement trajectory of the retroreflective member 14 is acquired in the aircraft coordinate system ΣA which is the coordinate system of the known installation base 15. Thus, if the flight position of the aircraft 11 is known, no change occurs in the coordinate system ΣA. As a result, the flight orientation estimation module 65 estimates the flight position and flight orientation of the aircraft 11 by tracking one retroreflective member 14 in the known coordinate system of the installation base 15.

In addition, since the retroreflective member 14 reflects the incident light to the emission source, tracking is easy regardless of the distance to the survey instrument 17. Then, the flight orientation estimation module 65 corrects the coordinate acquired by the tracking of the retroreflective member 14 using the change amount of the flight orientation acquired by the orientation change acquisition module 36.

Therefore, even when external influences such as wind or obstacles are applied to the aircraft 11, the error of the aircraft coordinate system ΣA in the known installation base 15 is corrected. Therefore, it is possible to easily estimate the flight orientation of the aircraft 11 with high accuracy regardless of the distance to the aircraft 11 without requiring a complicated configuration.

In the first embodiment, the retroreflective member 14 is provided to the aircraft 11. Further, the survey instrument 17 is provided to the ground facility 12 as a body separate from the aircraft 11. Thereby, utilization of the configuration of the existing aircraft control system 10 is possible. Therefore, the flight orientation of the aircraft 11 can be estimated with high accuracy without adding a new configuration.

### Second Embodiment

An aircraft control system according to a second embodiment will be described. While the aircraft control system 10 according to the second embodiment has a schematic configuration in common with the first embodiment, the second embodiment is different from the first embodiment in part of data used for processing and the sequence of processing is different from the first embodiment.

In general, an inertial navigation system is configured by including internal sensors such as an acceleration sensor 42 and an angular velocity sensor 43 connected to the flight state acquisition module 34. Such an inertial navigation system detects a rotation angle φ of the roll axis of the aircraft 11 and a rotation angle θ of the pitch axis based on the acceleration and angular velocity applied to the aircraft 11. Therefore, by using the detection values of the acceleration sensor 42 and the angular velocity sensor 43, the flight orientation estimation module 65 can estimate the rotation angle φ and the rotation angle θ of the aircraft 11 with higher accuracy.

The GPS sensor 41 connected to the flight state acquisition module 34 detects the position coordinate (pₓ, p_{y}, p_{z}) of the aircraft 11 in three dimensions by RTK (Real Time Kinetic)-GPS. Therefore, by using the detection value of the GPS sensor 41, the flight orientation estimation module 65 can estimate the position coordinate of the aircraft 11 with higher accuracy.

Therefore, the flight orientation estimation module 65 substitutes the obtained rotation angle φ, rotation angle θ, and position coordinate (pₓ, p_{y}, p_{z}) into the above-mentioned Expression 4. Thereby, the following Expression 6 is obtained.

Mv=0(v=(ψ, 1)^{t}) [Expression 6]

Here, M is a parameter matrix of 3i rows and 2 columns. As a result, the variable estimated by the flight orientation estimation module 65 is only rotation in the yaw direction. Therefore, the flight orientation estimation module 65 can estimate the flight orientation v more accurately.

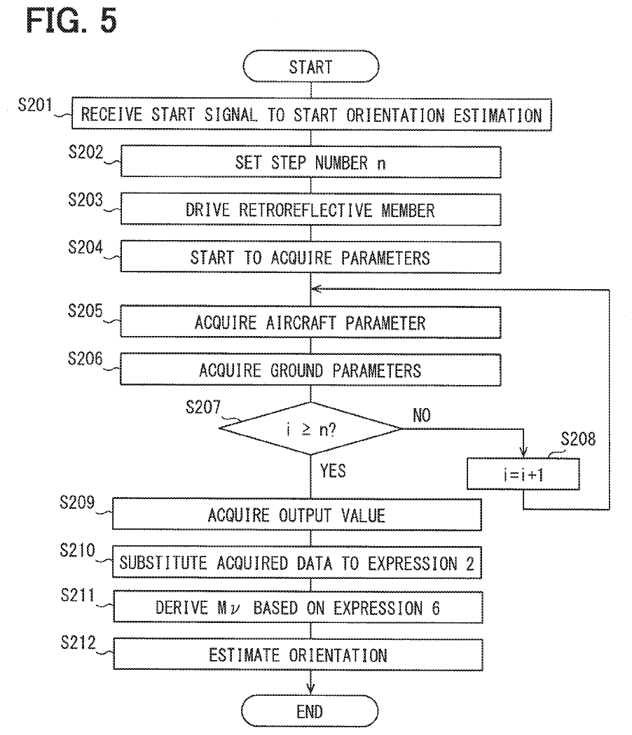

Next, the sequence of processing of a flowchart in the flight orientation estimation module 65 according to the second embodiment will be described based on FIG. 5. Description of processing common to the first embodiment is omitted. When the orientation estimation start signal is received (S201), the flight orientation estimation module 65 sets the number of measurement steps as the number of steps n (S202).

After setting the number of steps n, the flight orientation estimation module 65 drives the retroreflective member 14 by the retroreflective member driver 16 (S203). When the driving of the retroreflective member 14 is started, the flight orientation estimation module 65 starts acquisition of various parameters (S204). The flight orientation estimation module 65 acquires the aircraft side parameters (S205), and acquires the ground side parameters (S206).

When the acquisition of the parameters in the measurement step i is completed in S205 and S206, the flight orientation estimation module 65 determines whether the measurement step i has reached the step number n (S207). When the measurement step i has not reached the step number n (S207: No), the flight orientation estimation module 65 increments the measurement step i to i=i+1 (S208), and repeats the processing from S205 and S206.

On the other hand, when the measurement step i has reached the step number n (S207: Yes), the flight orientation estimation module 65 acquires output values of various sensors through the flight state acquisition module 34 (S209).

That is, the flight orientation estimation module 65 acquires the rotation angle φ of the roll axis and the rotation angle ψ of the pitch axis from the acceleration sensor 42 and the angular velocity sensor 43 through the flight state acquisition module 34. At the same time, the flight orientation estimation module 65 acquires the position coordinate (pₓ, p_{y}, p_{z}) from the GPS sensor 41 through the flight state acquisition module 34.

After the start of the acquisition of the parameters in S204, the flight orientation estimation module 65 determines the rotation angle φ, the rotation angle ψ, and the position coordinate (pₓ, p_{y}, p_{z}) in a range from when the acquisition of the parameters is started to when the acquisition of the parameters is determined to be completed in S207. The amount of change corresponds to the amount of change in each value from the start of driving of the retroreflective member 14 to the end of driving.

The flight orientation estimation module 65 substitutes the acquired data respectively into (φ, ψ) and (pₓ, p_{y}, p_{z}) in the above-mentioned “Expression 2” (S210). Then, the flight orientation estimation module 65 derives Mv that is the above-mentioned “Expression 6” (S211). Furthermore, the flight orientation estimation module 65 estimates the flight orientation v satisfying “Expression 5” from Mv derived in S211 (S212).

In the second embodiment, parameters are reduced using data acquired by various sensors through the flight state acquisition module 34. Therefore, the rotation angle φ, the rotation angle ψ, and the position coordinate (pₓ, p_{y}, p_{z}) are acquired as more accurate measured data without being estimated by the flight orientation estimation module 65. Therefore, the estimation accuracy of the flight orientation of the aircraft 11 can be further improved. In the second embodiment, the rotation angles φ, ψ and the position coordinate (pₓ, p_{y}, p_{z}) may be estimated or detected using an image or the like captured by a camera (not shown) mounted on the aircraft 11, for example.

### Third Embodiment

An aircraft control system according to a third embodiment will be described. The aircraft control system 10 according to the third embodiment has a schematic configuration in common with the first embodiment: the third embodiment is different from the first embodiment in a part of the sequence of processing.

In the third embodiment, the flight control module 35 shifts the aircraft 11 to an orientation stable mode before the flight orientation estimation module 65 estimates the flight orientation. Here, in the orientation stable mode, the rotational angle and translational displacement of each axis of the aircraft 11 are both close to zero. That is, when in the orientation stable mode, the flight control module 35 performs control to suppress the change in the rotation of each axis and the flight position of the aircraft 11.

The flight control module 35 controls the propulsive force of the thrusters 22 based on data detected by various sensors or a camera through the flight state acquisition module 34. Thereby, the aircraft 11 can suppress the change in the flight orientation and the flight position.

Specifically, the flight control module 35 controls the thrusters 22 so that the rotational displacement of each axis satisfies Expression 7 and the translational displacement ^{W}Δp_{AWi} satisfies Expression 8. In this case, the flight control module 35 controls the propulsive force of the thrusters 22 by controlling the number of rotations of the motors 23 of the thrusters 22 and the pitches of the propellers 24.

(Δϕᵢ, Δθᵢ, Δψᵢ)^{t}32 0 [Expression 7]

^{W}Δp_{AWi}=(Δpₓᵢ, Δp_{yi}, Δp_{zi})^{t}=0 [Expression 8]

As described above, the flight control module 35 controls the flight orientation and the flight position of the aircraft 11 to reduce errors due to the change in the rotation of each axis and the flight position of the aircraft 11.

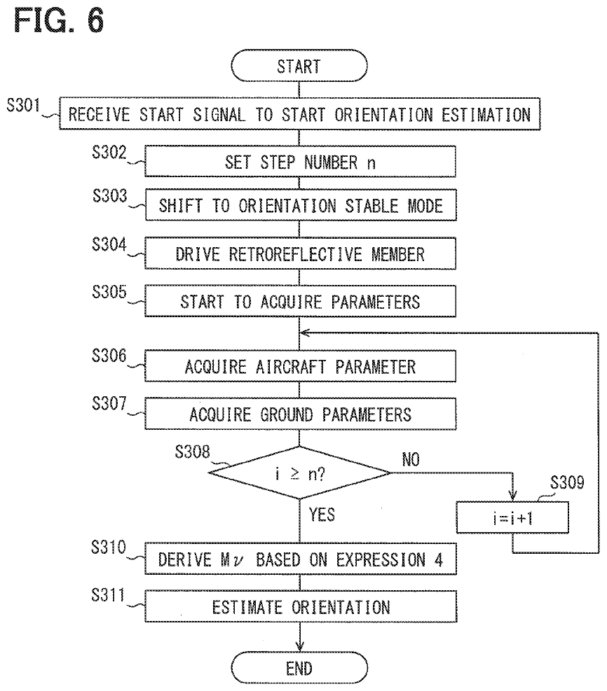

Next, the sequence of processing of a flowchart in the flight orientation estimation module 65 according to the third embodiment will be described based on FIG. 6. Description of processing common to the first embodiment is omitted.

Upon receiving the orientation estimation start signal (S301), the flight orientation estimation module 65 sets the number of measurement steps as the number of steps n (S302). When the flight orientation estimation module 65 sets the number of steps n in 5302, the flight control module 35 shifts the flight mode of the aircraft 11 to the orientation stable mode (S303).

That is, the flight control module 35 controls the number of rotations of the motor 23 and the pitch of the propeller 24 in each thruster 22 based on information acquired from various sensors and/or the camera through the flight state acquisition module 34. Thereby, the flight control module 35 limits the change in rotation on each axis and flight position of the aircraft 11.

The flight orientation estimation module 65 drives the retroreflective member 14 by the retroreflective member driver 16 when the flight control module 35 shifts the aircraft 11 to the orientation stable mode in S303 (S304). When driving of the retroreflective member 14 is started, the flight orientation estimation module 65 starts acquisition of various parameters (S305). The flight orientation estimation module 65 acquires the aircraft side parameters (S306), and acquires the ground side parameters (S307).

When the acquisition of the parameters in the measurement step i is completed in 5306 and 5307, the flight orientation estimation module 65 determines whether the measurement step i has reached the step number n (S308). When the measurement step i has not reached the step number n (S308: No), the flight orientation estimation module 65 increments the measurement step i to i=i+1 (S309), and repeats the processing from S306 and S307.

On the other hand, when the measurement step i has reached the step number n (S308: Yes), the flight orientation estimation module 65 derives My that becomes “Expression 4” (S310). Furthermore, the flight orientation estimation module 65 estimates the flight orientation v satisfying “Expression 5” from My derived in S310 (S311).

In the third embodiment, when the flight orientation estimation module 65 starts to estimate the flight orientation, the flight control module 35 shifts the aircraft 11 to the orientation stable mode. Thereby, the aircraft 11 flies in a state in which the flight control module 35 suppresses the changes in the rotation of each axis and the flight position. Therefore, various data acquired for estimation of the flight orientation reduce errors due to the changes in the rotation of each axis and the flight position of the aircraft 11. Therefore, the estimation accuracy of the flight orientation of the aircraft 11 can be further improved.

### Fourth Embodiment

An aircraft control system according to a fourth embodiment will be described.

The aircraft control system 10 according to the fourth embodiment has a schematic configuration in common with that of the first embodiment, but the fourth embodiment is different from the first embodiment in part of the sequence of processing. The estimation of the flight orientation of the aircraft 11 generally includes an orientation alignment step and a rate integration step.

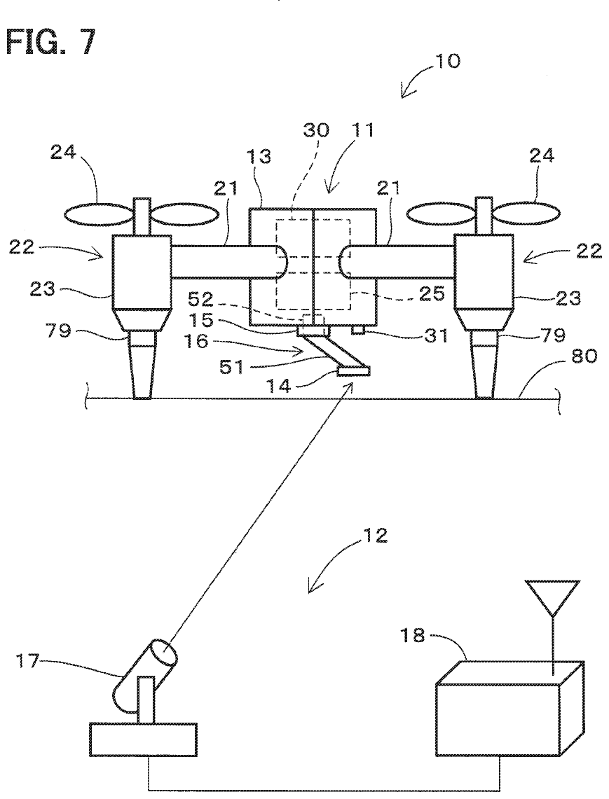

The orientation alignment step is a step of executing so-called calibration for matching the relationship between the aircraft coordinate system ΣA and the ground coordinate system ΣW before the aircraft 11 takes off. The rate integration step is a step of updating the relationship between the aircraft coordinate system ΣA and the ground coordinate system ΣW by sequentially calculating data such as acceleration, angular velocity, and positional information acquired through the flight state acquisition module 34 from the sensors such as the GPS sensor 41 or the like. In the fourth embodiment, the aircraft 11 is provided with legs 79 as shown in FIG. 7.

The legs 79 are provided below the thrusters 22 in the vertical direction, and support the aircraft 11 on the ground 80. The legs 79 can be foldable. The flight orientation estimation module 65 estimates the flight orientation in the orientation alignment step in which the aircraft 11 rests on the ground 80 before takeoff.

That is, the flight orientation estimation module 65 executes the orientation alignment process when the flight orientation is stable on the ground 80 before takeoff. In other words, this orientation alignment step corresponds to the orientation stable mode in which the flight orientation of the aircraft 11 is stable.

As a result, the rotational amount of each axis detected from the start of the orientation alignment process is established by Expression 9; the translational displacement ^{W}Δp_{AWi} detected from the start of the orientation alignment process is established by Expression 10.

(Δϕᵢ, Δθᵢ, Δψᵢ)^{t}=0 [Expression 9]

^{W}Δp_{AWi}=(Δpₓᵢ, Δp_{yi}, Δp_{zi})^{t}=0 [Expression 10]

As described above, by performing the orientation alignment process in a stable state before takeoff of the aircraft 11, the errors caused by the change of the rotation of each axis and the flight position of the aircraft 11 become almost “0”.

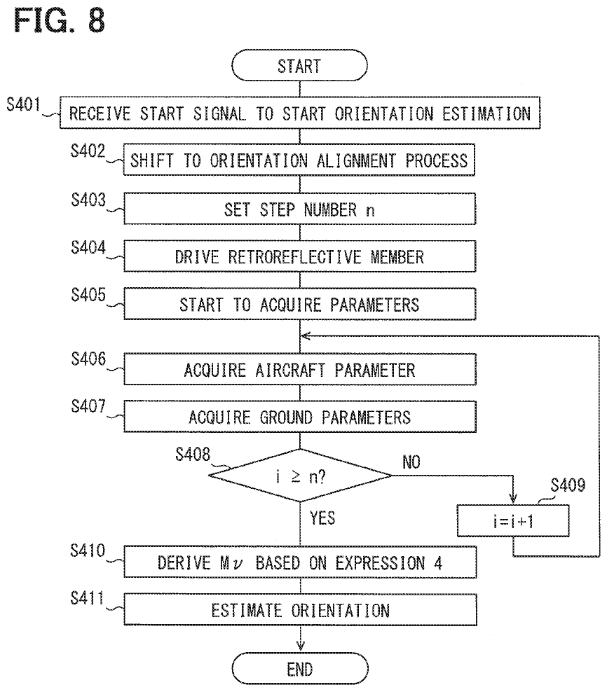

Next, the sequence of processing of a flowchart in the ground controller 61 including the flight orientation estimation module 65 according to the fourth embodiment will be described based on FIG. 8. Description of processing common to the first embodiment is omitted.

Upon receiving the orientation estimation start signal (S401), the flight orientation estimation module 65 proceeds to the orientation alignment process (S402) prior to the subsequent processes. That is, the flight orientation estimation module 65 sets the aircraft 11 on the ground 80 in a stable state before taking off through the flight control module 35. Thus, the aircraft 11 stands by on the ground 80 without flying.

When the flight orientation estimation module 65 shifts to the orientation alignment process in which the aircraft 11 is stopping flight, the flight orientation estimation module 65 sets the number of measurement steps as the step number n (S403). When the step number n is set, the flight orientation estimation module 65 drives the retroreflective member 14 by the retroreflective member driver 16 (S404).

When driving of the retroreflective member 14 is started, the flight orientation estimation module 65 starts acquisition of various parameters (S405). The flight orientation estimation module 65 acquires the aircraft side parameters (S406), and acquires the ground side parameters (S407).

When the acquisition of the parameters in the measurement step i is completed in S406 and S407, the flight orientation estimation module 65 determines whether the measurement step i has reached the step number n (S408). When the measurement step i has not reached the step number n (S408: No), the flight orientation estimation module 65 increments the measurement step i to i=i+1 (S409), and repeats the processing from S406 and S407.

On the other hand, when the measurement step i has reached the step number n (S408: Yes), the flight orientation estimation module 65 derives My that becomes “Expression 4” (S410). Furthermore, the flight orientation estimation module 65 estimates the flight orientation v satisfying “Expression 5” from My derived in S410 (S411).

In the fourth embodiment, the flight orientation estimation module 65 estimates the flight orientation before the aircraft 11 takes off. As a result, the aircraft 11 is in a state in which the changes in the rotation of each axis and the flight position on the ground 80 are suppressed. Although the data acquired for estimation of the flight orientation has an error due to the changes in the rotation of each axis and the flight position of the aircraft 11, such an error becomes almost to “0”. Therefore, the estimation accuracy of the flight orientation of the aircraft 11 can be further improved.

### Fifth Embodiment

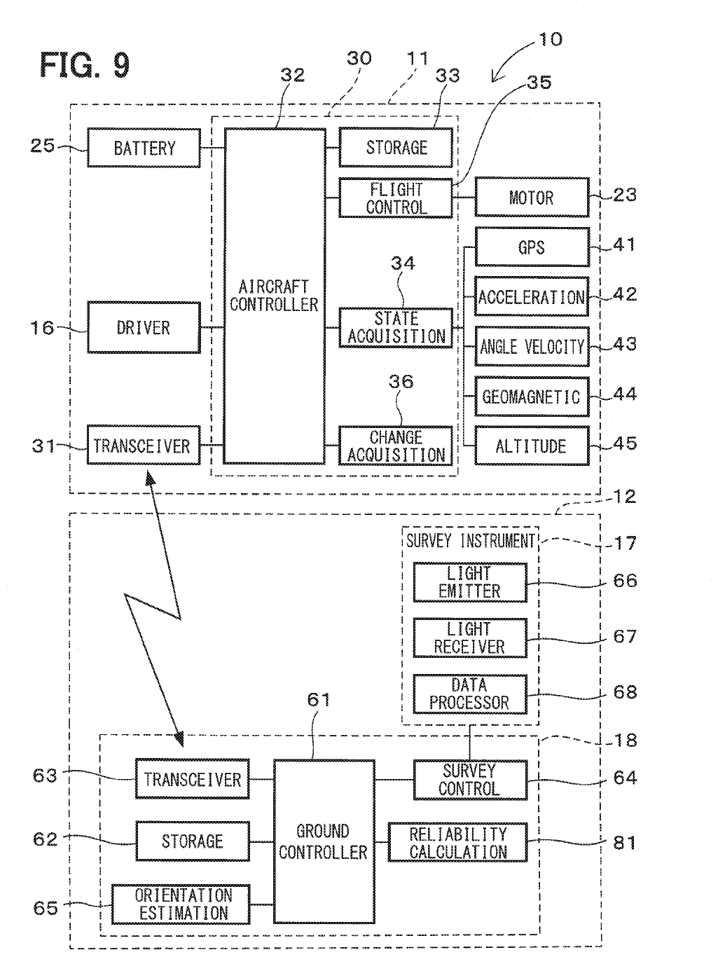

An aircraft control system according to a fifth embodiment will be described. The aircraft control system 10 according to the fifth embodiment includes a reliability calculation module (or circuit) 81 as shown in FIG. 9. As described in the first embodiment, the reliability calculation module 81 may be provided to be included in the ground controller 61. Further, the reliability calculation module 81 may be configured by including (i) a hardware configuration, or (ii) a software configuration, or (iii) a combination of the hardware configuration and the software configuration.

The reliability calculation module 81 calculates the reliability E of the flight orientation estimated by the flight orientation estimation module 65. At the same time, the reliability calculation module 81 notifies the operator of the calculated reliability E by appealing to the operator's five senses. The reliability calculation module 81 reports the reliability E with one of techniques that include (i) a visual technique such as a change in orientation of the aircraft 11 or displaying by a display (not shown), (ii) an auditory technique such as a buzzer ringing, and (iii) a tactile sense such as vibrating a part of the aircraft 11, for instance.

In addition, the reliability calculation module 81 discards the calculated reliability E when the calculated reliability E is out of a preset setting range. In this embodiment, the reliability calculation module 81 discards the flight orientation v estimated by the flight orientation estimation module 65 when the calculated reliability E is larger than the lower limit value Et. The lower limit value Et can be optionally set based on the performance required of the aircraft 11, for example.

Specifically, the flight orientation estimation module 65 estimates the flight orientation v using Expressions 4 and 5 as described in the first embodiment. Here, the reliability calculation module 81 calculates the reliability E based on Expression 11 as follows.

$$E = {arg min}_{v} {‖ Mv ‖}^{2} \qquad [ Expression 11 ]$$

The reliability E is an index indicating that as the value is smaller, the estimation has more accuracy. The operator using the aircraft 11 can optionally set the lower limit value Et with respect to the reliability E. When the calculated reliability E is larger than the set lower limit Et, the reliability calculation module 81 determines that the estimated flight orientation contains a large error.

Therefore, the reliability calculation module 81 discards the flight orientation v estimated by the flight orientation estimation module 65 when the calculated reliability E is larger than the lower limit Et. For example, when there is a disturbance such as wind, the reliability of the estimated flight orientation is affected. The flight orientation based on the reliability E with high estimation accuracy is used by determining whether the reliability E calculated by the reliability calculation module 81 is less than or equal to the lower limit Et. As a result, the accuracy of the estimation of the flight orientation is improved.

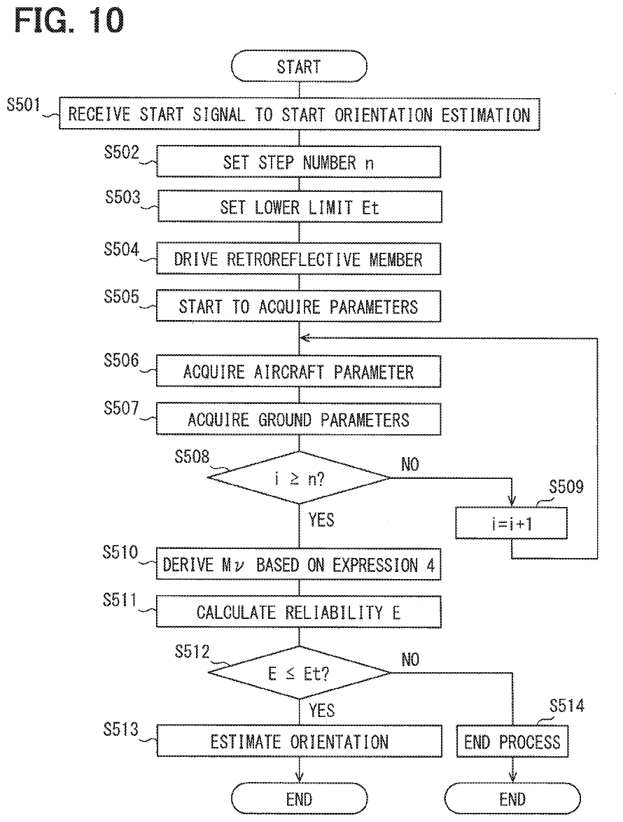

Next, the sequence of processing of a flowchart in the ground controller 61 including the flight orientation estimation module 65 and the reliability calculation module 81 according to the fifth embodiment will be described based on FIG. 10. Description of processing common to the first embodiment is omitted.

Upon receiving the orientation estimation start signal (S501), the flight orientation estimation module 65 sets the number of measurement steps as the number of steps n (S502). After setting the number of steps n, the flight orientation estimation module 65 receives the setting of the lower limit value Et (S503).

The flight orientation estimation module 65 receives the lower limit value Et which the operator optionally sets. The operator inputs the lower limit Et through, for example, the ground control apparatus 18 in the ground facility 12. In response to accepting the setting of the lower limit value Et, the flight orientation estimation module 65 drives the retroreflective member 14 by the retroreflective member driver 16 (S504).

When the driving of the retroreflective member 14 is started, the flight orientation estimation module 65 starts acquisition of various parameters (S505). The flight orientation estimation module 65 acquires the aircraft side parameter (S506) and acquires the ground side parameter (S507).

When the acquisition of the parameters in the measurement step i ends in 5506 and S507, the flight orientation estimation module 65 determines whether the measurement step i has reached the step number n (S508). When the measurement step i has not reached the step number n (S508: No), the flight orientation estimation module 65 increments the measurement step i to i=i+1 (S509), and repeats the processing from S506 and S506.

On the other hand, when the measurement step i has reached the step number n (S508: Yes), the flight orientation estimation module 65 derives Mv that becomes “Expression 4” (S510). The reliability calculation module 81 calculates the reliability E from Expression 11 using Mv derived in S510 (S511). In this case, the reliability calculation module 81 may notify the operator of the reliability E calculated in S511 through five senses. The reliability calculation module 81 compares the reliability E calculated in S511 with the lower limit value Et set in S503 (S512). That is, the reliability calculation module 81 determines whether the calculated reliability E is less than or equal to the lower limit Et.

When determining that the reliability E is equal to or lower than the lower limit Et in S512 (S512: Yes), the reliability calculation module 81 estimates the flight orientation satisfying “Expression 5” from Mv derived in S510 (S513). On the other hand, when determining that the reliability E is larger than the lower limit Et in S512 (S512: No), the reliability calculation module 81 discards Mv derived in S510 and ends the process of orientation estimation of the aircraft 11 in S510 (S514).

In the fifth embodiment, the reliability calculation module 81 calculates the reliability E based on the derived Mv, and determines whether the calculated reliability E is in a preset range. Then, when the reliability cannot be ensured based on the reliability E, the reliability calculation module 81 ends the process of orientation estimation of the aircraft 11. Thus, the influence of disturbance such as wind is eliminated, and the reliability of the estimated flight orientation is enhanced. Therefore, the accuracy of the estimation of the flight orientation can be further improved.

### Sixth Embodiment

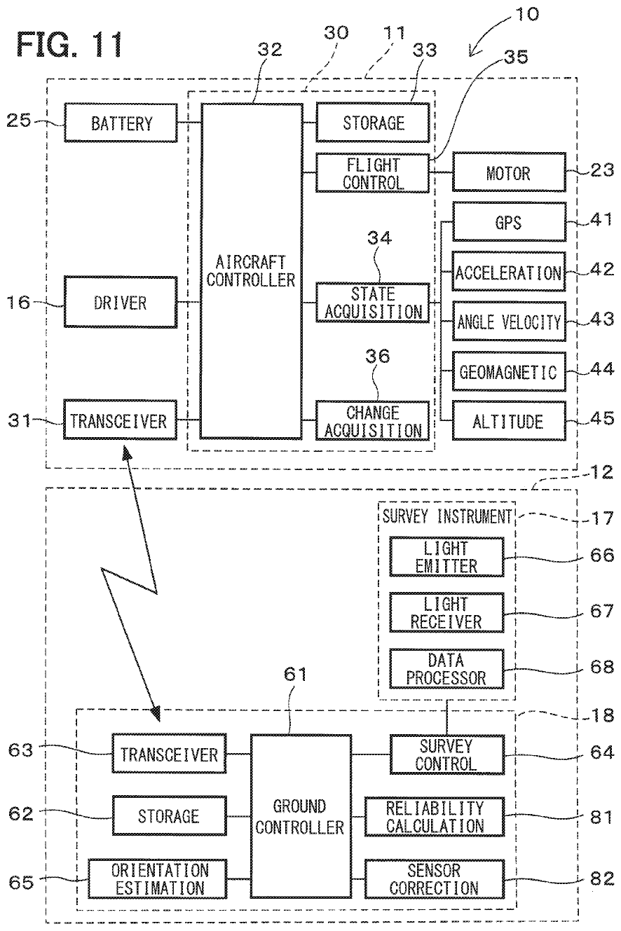

An aircraft control system according to a sixth embodiment will be described. The aircraft control system 10 according to the sixth embodiment is a modification of the fifth embodiment, and includes a sensor correction module (circuit) 82 as shown in FIG. 11. As described in the first embodiment, the sensor correction module 82 may be provided to be included in the ground controller 61. Further, the sensor correction module 82 may be configured to include (i) a hardware configuration, or (ii) a software configuration, or (iii) a combination of the hardware configuration and the software configuration.

The various sensors mounted on the aircraft 11 may produce unexpected errors depending on the surrounding conditions of flight. For example, in the case of the geomagnetic sensor 44, if there is a structure or the like that causes destabilization of a magnetic field such as a steel frame around the aircraft 11, an error occurs and the reliability decreases. On the other hand, for the estimation of the flight orientation of the aircraft 11 by the flight orientation estimation module 65, high accuracy can be obtained depending on the conditions.

Therefore, when it is determined that the reliability E of the flight orientation estimated by the flight orientation estimation module 65 is high, the sensor correction module 82 determines that there is an error in the data detected by the various sensors of the aircraft 11. The output value acquired from the various sensors connected with the flight state acquisition module 34 is corrected. For example, when an error occurs in the geomagnetic sensor 44 as described above, the sensor correction module 82 corrects the output value of the geomagnetic sensor 44 based on the flight orientation estimated by the flight orientation estimation module 65.

Specifically, when the reliability E of the flight orientation is equal to or less than the lower limit Et, the sensor correction module 82 determines whether the reliability E is equal to or less than a predetermined required correction value Ec. Then, when the reliability E is equal to or less than the required correction value Ec, the sensor correction module 82 corrects the output values from the various sensors. In this case, the required correction value Ec can be set to any value based on the reliability of the aircraft 11 by the operator.

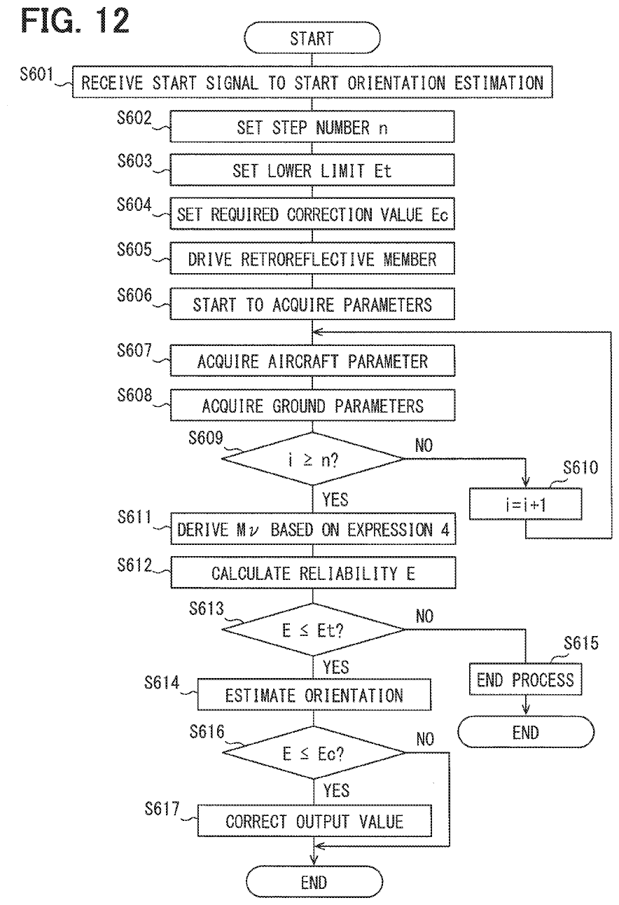

Next, the sequence of processing of a flowchart in the ground controller 61 including the flight orientation estimation module 65, the reliability calculation module 81, and the sensor correction module 82 according to the sixth embodiment will be described based on FIG. 12. The description of the processing common to the fifth embodiment will be omitted.

When the orientation estimation start signal is received (S601), the flight orientation estimation module 65 sets the number of measurement steps as the number of steps n (S602). After setting the number of steps n, the flight orientation estimation module 65 receives the setting of the lower limit Et (S603). At the same time, the sensor correction module 82 receives the setting of the required correction value Ec (S604).

The sensor correction module 82 receives the required correction value Ec optionally set by the operator. The operator inputs the required correction value Ec, for example, through the ground control apparatus 18 in the ground facility 12.

When the setting of the lower limit value Et and the required correction value Ec is received, the flight orientation estimation module 65 drives the retroreflective member 14 by the retroreflective member driver 16 (S605). When driving of the retroreflective member 14 is started, the flight orientation estimation module 65 starts acquisition of various parameters (S606). The flight orientation estimation module 65 acquires the aircraft side parameters (S607), and acquires the ground side parameters (S608).

When the acquisition of the parameters in the measurement step i is completed in S607 and 5608, the flight orientation estimation module 65 determines whether the measurement step i has reached the step number n (S609). When the measurement step i has not reached the step number n (S609: No), the flight orientation estimation module 65 increments the measurement step i to i=i+1 (S610), and repeats the processing of S607 and 5608.

On the other hand, when the measurement step i has reached the step number n (S609: Yes), the flight orientation estimation module 65 derives Mv that is “Expression 4” (S611). The reliability calculation module 81 calculates the reliability E from Expression 11 using Mv derived in S611 (S612). The reliability calculation module 81 compares the reliability E calculated in S612 with the lower limit value Et set in S603 (S613).

When the reliability calculation module 81 determines that the reliability E is less than or equal to the lower limit Et in S613 (S613: Yes), it estimates the flight orientation satisfying “Expression 5” from Mv derived in S611 (S614). On the other hand, when the reliability calculation module 81 determines that the reliability E is greater than the lower limit Et in S613 (S613: No), the process of estimating the orientation of the aircraft 11 ends, assuming that the reliability E calculated in S612 is low (S615).

When the flight orientation is estimated in S614, the sensor correction module 82 compares the reliability E calculated in S612 with the required correction value Ec set in S604 (S616). When the sensor correction module 82 determines that the reliability E is equal to or less than the correction required value Ec in S616 (S616: Yes), the sensor correction module 82 corrects the output values of various sensors connected with the flight state acquisition module 34 from the estimated flight orientation v (S617). On the other hand, when the sensor correction module 82 determines that the reliability E is larger than the required correction value Ec in S616 (S616: No), the process ends.

In the sixth embodiment, the sensor correction module 82 corrects the output values of the various sensors that connected with the flight state acquisition module 34 when the calculated reliability E is in a reliable range. As a result, even when there is a cause that causes errors of various sensors around the aircraft 11, the correction of the various sensors becomes possible. Therefore, it is possible to improve the reliability of various sensors connected with the flight state acquisition module 34 as well as to improve the accuracy of the estimation of the flight orientation.

### Seventh Embodiment

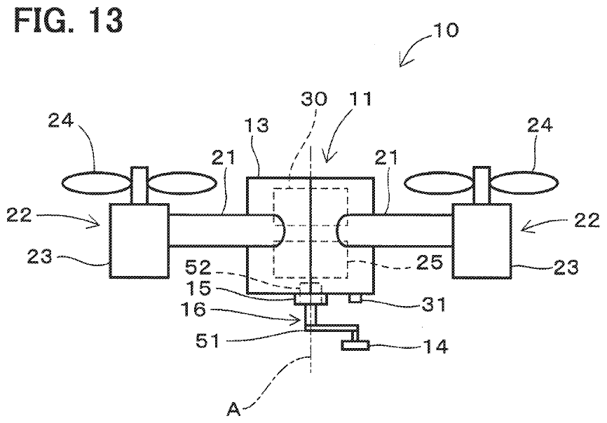

An aircraft control system 10 according to a seventh embodiment will be described. The aircraft 11 used in the aircraft control system 10 according to the seventh embodiment differs from the first embodiment in the configuration of the retroreflective member driver 16 as shown in FIG. 13. In the seventh embodiment, the retroreflective member driver 16 rotationally drives the retroreflective member 14 about the axis A that is parallel to the yaw axis of the aircraft 11; the yaw axis is the Z axis of the aircraft coordinate system ΣA. That is, the retroreflective member 14 rotates about the axis A on which the installation base 15 is centered,

In the seventh embodiment, the support member 51 of the retroreflective member driver 16 is rotated about the axis A parallel to the yaw axis of the aircraft 11 by the actuator 52. Thereby, the retroreflective member driver 16 rotationally drives the retroreflective member 14 supported at the tip of the support member 51 about the axis A. The yaw axis is an axis passing through the center of the main body 13 of the aircraft 11. As a result, the retroreflective member driver 16 does not require a complicated driving mechanism, and the configuration can be simplified.

In the seventh embodiment, the retroreflective member driver 16 rotationally drives the retroreflective member 14 about an axis A parallel with the yaw axis of the aircraft 11. Thus, the actuator for driving the retroreflective member 14 is uniaxial. Therefore, the axis of the retroreflective member 14 is reduced, and the accuracy can be improved.

Further, in the seventh embodiment, the retroreflective member 14 circularly moves on the XY plane in the aircraft coordinate system ΣA. Therefore, the flight orientation estimation module 65 performs processing of estimating the flight orientation by regarding the movement of the retroreflective member 14 as a circular motion. Therefore, the calculation processing can be simplified and the error can be reduced; the accuracy of the estimation of the flight orientation can be further improved.

### Other Embodiments

The several embodiments described above each have described an example in which the retroreflective member 14 is provided in the aircraft 11, and tracked by the survey instrument 17 in the ground facility 12 as a body separate from the aircraft 11. However, as long as the relative relationship between the retroreflective member 14 and the survey instrument 17 tracking the retroreflective member 14 is maintained, the respective installation positions of the retroreflective member 14 and the survey instrument 17 are not limited to the above-described embodiments. For example, the retroreflective member 14 and survey instrument 17 can be differently configured as follows.

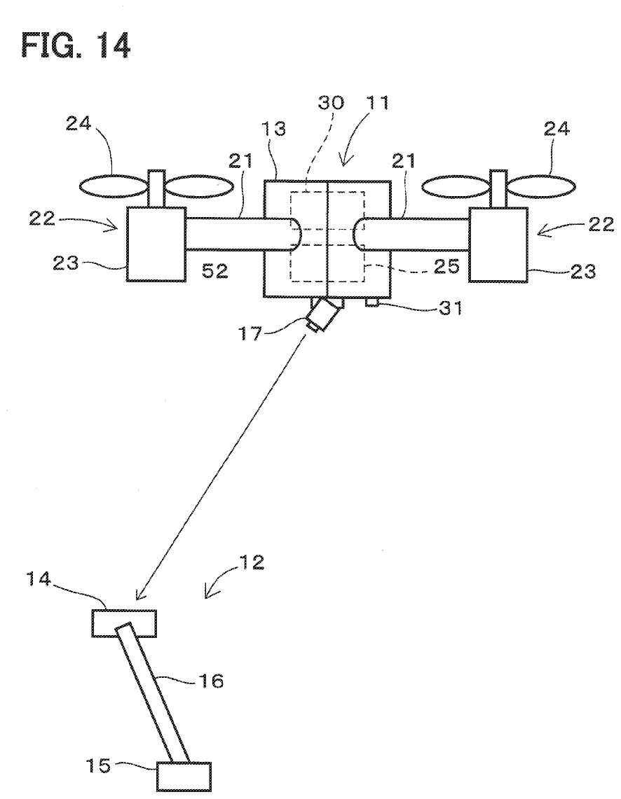

In the example shown in FIG. 14, the survey instrument 17 is provided to the aircraft 11, and the retroreflective member 14 is provided to the ground facility 12 as a body separate from the aircraft 11. In this case, the installation base 15 and the retroreflective member driver 16 for driving the retroreflective member 14 are provided in the ground facility 12.

Further, instead of driving the retroreflective member 14 according to the first embodiment, the survey instrument 17 may be driven relative to the installation base 15. Even in this case, since the coordinate of the survey instrument 17 with respect to the installation base 15 is known, it is possible to estimate the flight orientation with high accuracy. Driving the survey instrument 17 can reduce the situation where the retroreflective member 14 becomes a shadow of the aircraft 11 due to the flight orientation of the aircraft 11. Therefore, the accuracy of following or tracking the retroreflective member 14 is further improved.

The present disclosure is not limited to the embodiments described above but may be modified in various ways without departing from the spirit of the disclosure. For example, in the above embodiments, an example in which each embodiment is applied individually has been described. However, the aircraft control system 10 may be applied by combining a plurality of embodiments. Further, for example, in the above-described several embodiments, an example has been described in which the flight orientation estimation module 65 performing calculation processing is executed by the ground control apparatus 18 in the ground facility 12. The flight orientation estimation module 65 may however be provided to the aircraft 11.

Although the present disclosure has been described based on the examples, it is understood that the present disclosure is not limited to the examples and structures. The present disclosure also includes various modifications and variations within the equivalent range. In addition, various combinations and forms, and further, other combinations and forms including only one element, or more or less than these elements are also within the sprit and the scope of the present disclosure.

For reference to further explain features of the present disclosure, the description is added as follows.

A small aircraft so-called drone has recently become widespread. The aircraft flies mainly by wireless or wired remote control by an operator on the ground, or by autonomous control without operation of an operator according to a preset flight plan. In any case, the flight position or flight orientation of the aircraft is monitored at a position of a ground base or an operator distant from the aircraft. As described above, since the aircraft is remotely monitored, it has been proposed to use a camera as in a related art, for example. In such a related art, a camera is mounted in an aircraft to recognize a marker installed separate from the aircraft; the marker may be such as a retroreflective member or a display board on which a specific image is displayed. Based on the image of the marker recognized by the camera, the flight orientation of the aircraft is estimated.

However, when the distance between the marker and the aircraft increases, the camera mounted on the aircraft has difficulty in capturing the marker. For example, in response to increasing the magnification ratio of the camera as the distance between the marker and the aircraft increases, the field of view becomes narrow. This poses an issue that the stable image capture of the marker by the camera becomes difficult as the distance between the marker and the aircraft increases.

It has also been proposed to measure a marker mounted on an aircraft with a survey instrument on the ground, acquire polar coordinates of the aircraft, and control the flight position and flight orientation of the aircraft based on the acquired polar coordinates. Here, in the case where only one marker is used, it is difficult to estimate the flight position or flight orientation accurately. The flight position or flight orientation is thus estimated by rate integration using an internal sensor such as an acceleration sensor or an angular velocity sensor. However, in this case, an error in integration of the internal sensor increases an error in the estimated flight position and flight orientation. In contrast, when the number of markers is increased to improve capture ability or estimation accuracy, there is an issue to complicate the configuration.

It is thus desired to provide an aircraft control system that facilitates accurate estimation of the flight orientation of the aircraft regardless of the distance to the aircraft without requiring a complicated configuration.

Examples of the present disclosure described herein are set forth in the following clauses.

According to a first example of the present disclosure, an aircraft control system is provided to include an unmanned aircraft, a retroreflective member, a survey instrument, and a control apparatus. The retroreflective member is configured to reflect light to an emission source. The survey instrument is configured to track the retroreflective member based on the light reflected by the retroreflective member and survey a distance to the retroreflective member and an angle of the retroreflective member. The control apparatus is configured to control a flight of the aircraft by providing the aircraft with a survey result surveyed by the survey instrument and a preset target position. The aircraft control system further includes an installation base, a retroreflective member driver, an orientation change acquisition module, and a flight orientation estimation module. The installation base is provided integrally or separately with the aircraft; on the installation base, the retroreflective member is installed. The retroreflective member driver is configured to drive the retroreflective member so as to be movable relative to the installation base. The orientation change acquisition module is configured to acquire a change in a flight orientation of the aircraft, for instance, by using an internal sensor such as an acceleration sensor, or an angle velocity sensor. The flight orientation estimation module is configured to estimate a latest flight orientation of the aircraft from (i) a movement trajectory of the retroreflective member acquired from the survey result and (ii) the change in the flight orientation of the aircraft acquired by the orientation change acquisition module.

As an optional example of the first example, in the aircraft control system, an individual one (module) of the orientation change acquisition module and the flight orientation estimation module may be configured to include (i) hardware circuit, or (ii) a central processing unit (CPU) along with memory storing instructions executed by the CPU, or (iii) both the hardware circuit and the CPU along with memory.

Thus, the flight orientation estimation module estimates the flight orientation of the aircraft based on the movement trajectory of the retroreflective member. Therefore, it is sufficient for the survey instrument to track a single retroreflective member. That is, the retroreflective member to be tracked is driven relative to the known installation base by the retroreflective member driver.

Therefore, as for the retroreflective member, the movement trajectory is acquired in the coordinate system of the known installation base. Thus, by maintaining the flight position of the aircraft constant, no change occurs in the coordinate system of the installation base. As a result, the flight orientation estimation module estimates the flight position and flight orientation of the aircraft by tracking one retroreflective member in the coordinate system of the known installation base. In addition, the retroreflective member reflects incident light to the emitting source; thus, tracking of the retroreflective member is easy regardless of the distance to the survey instrument.

Then, the flight orientation estimation module corrects the movement trajectory acquired by tracking of the retroreflective member, using the change amount of the flight orientation acquired by the orientation change acquisition module. Therefore, even when external influences such as wind or obstacles are added to the aircraft, the error of the coordinate system in the known installation base is corrected. Therefore, the flight orientation of the aircraft can be easily estimated with high accuracy regardless of the distance to the aircraft without requiring a complicated configuration,

According to a second example of the present disclosure, an aircraft control system is provided to include an unmanned aircraft, a retroreflective member configured to reflect light to an emission source, an installation base provided integrally or separately with the aircraft, a retroreflective member driver, and a survey instrument. The retroreflective member is installed on the installation base. The retroreflective member driver is configured to drive the retroreflective member so as to be movable relative to the installation base. The survey instrument is configured to track the retroreflective member based on the light reflected by the retroreflective member and survey a distance to the retroreflective member and an angle of the retroreflective member, providing a survey result. The aircraft control system further includes one or more controllers configured to acquire a change in a flight orientation of the aircraft, and estimate a latest flight orientation of the aircraft from (i) a movement trajectory of the retroreflective member acquired from the survey result and (ii) the acquired change in the flight orientation of the aircraft, to control a flight of the aircraft.

As an optional example of the second example, in the aircraft control system, an individual one (controller) of the one or more controllers may be configured to include (i) hardware circuit, or (ii) a central processing unit (CPU) along with memory storing instructions executed by the CPU, or (iii) both the hardware circuit and the CPU along with memory.

As another optional example of the second example, an individual one (i.e., controller) of the one or ore controllers may be provided to either the aircraft, or a body separated from the aircraft.

What is claimed is:

1. An aircraft control system comprising:
an unmanned aircraft;
a retroreflective member configured to reflect light to an emission source;
a survey instrument configured to
track the retroreflective member based on the light reflected by the retroreflective member and
survey a distance to the retroreflective member and an angle of the retroreflective member; and
a control apparatus configured to control a flight of the aircraft by providing the aircraft with a survey result surveyed by the survey instrument and a preset target position,
the aircraft control system further comprising:
an installation base provided integrally or separately with the aircraft, the installation base on which the retroreflective member is installed;
a retroreflective member driver configured to drive the retroreflective member so as to be movable relative to the installation base;
an orientation change acquisition module configured to acquire a change in a flight orientation of the aircraft; and
a flight orientation estimation module configured to estimate a latest flight orientation of the aircraft from (i) a movement trajectory of the retroreflective member acquired from the survey result and (ii) the change in the flight orientation of the aircraft acquired by the orientation change acquisition module.

2. The aircraft control system according to claim 1, wherein:
the retroreflective member driver is capable of rotating the retroreflective member about an axis parallel with a yaw axis; and
the retroreflective member driver includes a support member configured to support the retroreflective member.

3. The aircraft control system according to claim 1, wherein:
the retroreflective member is attached to the aircraft; and
the survey instrument is provided to a body separate from the aircra

4. The aircraft control system according to claim 1, wherein:
the survey instrument is attached to the aircraft; and
the retroreflective member is provided to a body separate from the aircraft.

5. The aircraft control system according to claim 1, further comprising:
a flight state acquisition module configured to acquire a flight state of the aircraft,
wherein the flight orientation estimation module is configured to estimate the flight orientation of the aircraft using the flight state of the aircraft acquired by the flight state acquisition module.

6. The aircraft control system according to claim 5, wherein
the flight state acquisition module is connected with a velocity information sensor configured to detect an angular velocity and translational acceleration of the aircraft.

7. The aircraft control system according to claim 5, wherein
the flight state acquisition module is connected with a position information sensor configured to detect translational position information of the aircraft.

8. The aircraft control system according to claim 1, wherein:
the aircraft includes a flight control module configured to control the flight orientation of the aircraft based on the change in the flight orientation of the aircraft acquired by the flight state acquisition module; and
the flight orientation estimation module is configured to estimate the flight orientation of the aircraft in an orientation stable mode in which the change in the flight orientation of the aircraft is limited by the flight control module.

9. The aircraft control system according to claim 1, further comprising:
a reliability calculation module configured to
calculate a reliability of the flight orientation of the aircraft estimated from the movement trajectory of the retroreflective member or the survey instrument and
report the calculated reliability.

10. The aircraft control system according to claim 9, wherein
the reliability calculation module is configured to discard the flight orientation estimated by the flight orientation estimation module when the reliability is outside a predetermined range.

11. The aircraft control system according to claim 9, further comprising:
a correction module configured to correct a value acquired by the flight state acquisition module, the value being used by the flight orientation estimation module so as to estimate the flight orientation according to the reliability calculated by the reliability calculation module.

12. An aircraft control system comprising:
an unmanned aircraft;
a retroreflective member configured to reflect light to an emission source;
an installation base provided integrally or separately with the aircraft, the installation base on which the retroreflective member is installed;
a retroreflective member driver configured to drive the retroreflective member so as to be movable relative to the installation base;
a survey instrument configured to
track the retroreflective member based on the light reflected by the retroreflective member and
survey a distance to the retroreflective member and an angle of the retroreflective member, providing a survey result; and
one or more controllers configured to
acquire a change in a flight orientation of the aircraft, and
estimate a latest flight orientation of the aircraft from (i) a movement trajectory of the retroreflective member acquired from the survey result and (ii) the acquired change in the flight orientation of the aircraft, to control a flight of the aircraft.
